(19) United States
(12) Patent Application Publication
(10) Pub. No.: US 2013/0076049 A1
(43) Pub. Date: Mar. 28, 2013

(54) STRIKER FOR A SEAT

(71) Applicant: Thomas Buchner, Allershausen (DE)

(72) Inventor: Thomas Buchner, Allershausen (DE)

(73) Assignee: LEAR CORPORATION, Southfield, MI (US)

(21) Appl. No.: 13/247,142

(22) Filed: Sep. 28, 2011

(51) Int. Cl. E05B 15/02

(52) U.S. Cl. 292/340

(57) ABSTRACT

A striker that may be used with a latch assembly. The striker may include first and second mounting flanges and a striker body. Striker body may include an indentation that may extend toward the second mounting flange.

### TECHNICAL FIELD

The present application relates to a striker that may be used with a vehicle seat.

### BACKGROUND

A striker member is disclosed in U.S. Pat. No. 7,490,908.

### SUMMARY

In at least one embodiment, a striker is provided. The striker may include first and second mounting flanges and a striker body. The striker body may extend from the first mounting flange to the second mounting flange. The striker body may include an indentation that extends toward the second mounting flange.

In at least one embodiment, a striker for a vehicle seat is provided. The striker may include first and second mounting flanges and a striker body. The striker body may include first, second, and third portions. The first portion may extend from the first mounting flange. The second portion may extend from the second mounting flange. The third portion may extend from the mouth first mounting flange to the second mounting flange. The third portion may include an indentation and a tab. The tab may be disposed adjacent to the indentation and may protrude from the third portion.

### BRIEF DESCRIPTION OF THE DRAWINGS

FIGS. 1 and 2 are perspective views of an exemplary striker.

FIG. 3 is a section view of the striker along section line 3-3.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

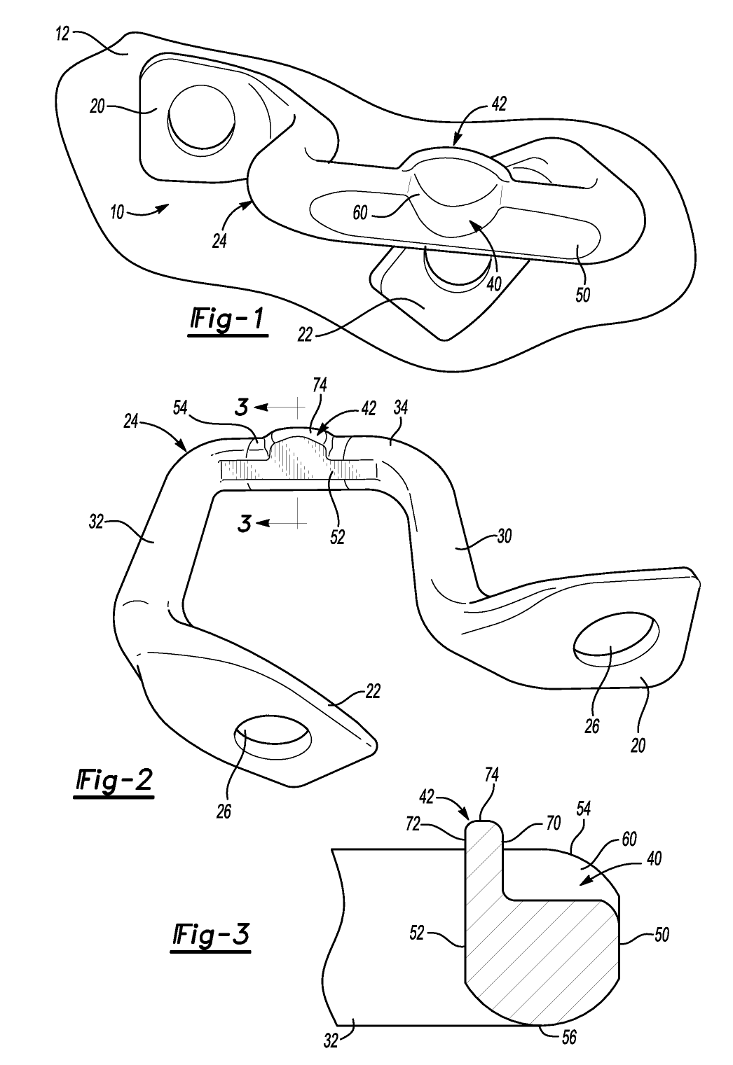

Referring to FIGS. 1-3, an exemplary striker 10 is shown. The striker 10 may be used with a latch assembly, such as a latch assembly that may be provided with a vehicle seat. For example, the striker 10 may be mounted on a mounting surface 12, such as a vehicle body structure, and may engage a latch assembly disposed on a vehicle seat. In at least one embodiment, the striker 10 may have a unitary or one-piece construction. In addition, the striker 10 may be made of any suitable material, such as a metal or metal alloy. The striker 10 may include a first mounting flange 20, a second mounting flange 22, and a striker body 24.

The first and second mounting flanges 20, 22 may facilitate mounting of the striker 10 to the mounting surface 12. For example, the first and second mounting flanges 20, 22 may each include a through hole 26 that may receive a fastener that facilitates mounting to the mounting surface 12. The first mounting flange 20 may be spaced apart from the second mounting flange 22. In addition, the first and second mounting flanges 20, 22 may be disposed at an angle relative to each other and extend in different directions.

A striker body 24 may extend from the first mounting flange 20 to the second mounting flange 22. In at least one embodiment, the striker body 24 may be substantially U-shaped. The striker body 24 may include a first portion 30, a second portion 32, and a third portion 34.

The first portion 30 may extend from the first mounting flange 20. The second portion 32 may extend from the second mounting flange 22. The first and second portions 30, 32 may be spaced apart from each other and may extend substantially parallel to each other in one or more embodiments. In addition, the first and second portions 30, 32 may have a substantially circular cross section in one or more embodiments.

The third portion 34 may extend from the first mounting flange 20 to the second mounting flange 22. The third portion 34 may have a different cross section than the first and/or second portions 30, 32 in one or more embodiments. The third portion 34 may include an indentation 40 and a tab 42. The indentation 40 and the tab 42 may be disposed substantially in the center of the third portion 34 in one or more embodiments. The tab 42 may provide an enlarged cross section that may be configured to engage the latch assembly to help withstand lateral load forces. In at least one embodiment, the third portion 34 may include a first surface 50, a second surface 52, a third surface 54, and a fourth surface 56.

The first and second surfaces 50, 52 may be disposed opposite each other. In at least one embodiment, the first and second surfaces 50, 52 may be the substantially planar and may extend substantially parallel to each other. From the perspective shown in FIG. 1, the first and second surfaces 50, 52 are disposed along the front and rear of the third portion 34.

The third and fourth surfaces 54, 56 may extend from the first surface 50 to the second surface 52 and may be disposed opposite each other. From the perspective shown in FIG. 1, the third and fourth surfaces 54, 56 are disposed along the top and bottom of the third portion 34.

The indentation 40 may extend from the first surface 50 toward the second surface 52. In addition, the indentation 40 may extend from the third surface 54 toward the fourth surface 56. As such, the indentation 40 may be spaced apart from the second and fourth surfaces 52, 56. The indentation 40 may be disposed adjacent to the tab 42 and may be at least partially defined by a curved surface 60. The curved surface 60 may extend from the first surface 50 toward the second surface 52. Moreover, the curved surface 60 may be spaced apart from the second and fourth surfaces 52, 56. The curved surface 60 may have first and second ends that are disposed opposite each other. The first and second ends may be located on the third surface 54 and/or adjacent to the tab 42.

The tab 42 may be disposed adjacent to the indentation 40. In at least one embodiment, the tab 42 may extend outwardly from the third surface 54 to increase the cross sectional area of the third portion 34 proximate the tab 42. The tab 42 may include a first tab surface 70, a second tab surface 72, and a third tab surface 74.

The first tab surface 70 may be disposed between the first and second surfaces 50, 52. In addition, the first tab surface 70 may extend from the third tab surface 74 to the curved surface 60 of the indentation 40 in one or more embodiments. The first tab surface 70 may be disposed substantially parallel to the second tab surface 72 and/or the first or second surfaces 50, 52 in one or more embodiments. The second tab surface 72 may be disposed opposite the first tab surface 70. In addition, the second tab surface 72 may be disposed parallel to at least a portion of the second surface 52 in one or more embodiments. Moreover, the second tab surface 72 may be coextensive with or may be offset from the second surface 52 in one or more embodiments.

The third tab surface 74 may extend from the first tab surface 70 to the second tab surface 72. In addition, the third tab surface 74 may extend from the third surface 54 and may be curved in one or more embodiments. The third tab surface 74 is depicted as the top of the tab 42 from the perspective shown. The distance between the third tab surface 74 and the fourth surface 56 may be greater than the distance between the third surface 54 and the fourth surface 56 in areas located on either side of the indentation 40.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A striker comprising:
first and second mounting flanges that are spaced apart from each other and that each have a through hole; and
a striker body that extends from the first mounting flange to the second mounting flange;
wherein the striker body includes an indentation that extends toward the second mounting flange.

2. The striker of claim 1 wherein the striker body is substantially U-shaped.

3. The striker of claim 1 wherein the striker body includes a first surface and a second surface disposed opposite the first surface, wherein the indentation extends from the first surface toward the second surface.

4. The striker of claim 3 wherein the first and second surfaces are disposed substantially parallel to each other.

5. The striker of claim 3 wherein the indentation is includes a curved surface that extends from the first surface toward the second surface such that the curved surface is spaced apart from the second surface.

6. The striker of claim 3 further comprising a tab disposed next to the indentation, wherein the tab includes a first tab surface that is disposed between the first and second surfaces.

7. The striker of claim 6 wherein the first tab surface is disposed substantially parallel to the first surface and/or the second surface.

8. A striker for a vehicle seat comprising:
first and second mounting flanges that are spaced apart from each other and that each have a through hole for receiving a fastener that facilitates mounting to a mounting surface; and
a striker body having:
a first portion that extends from the first mounting flange;
a second portion that extends from the second mounting flange; and
a third portion that extends from the first mounting flange to the second mounting flange;
wherein the third portion includes an indentation and a tab that is disposed adjacent to the indentation and that protrudes from the third portion.

9. The striker of claim 8 wherein the first and second portions have a different cross section than the third portion.

10. The striker of claim 8 wherein the third portion includes a first surface and a second surface disposed opposite the first surface.

11. The striker of claim 10 wherein the first and second surfaces are substantially planar.

12. The striker of claim 10 further comprising third and fourth surfaces that extend from the first surface to the second surface, wherein the third and fourth surfaces are disposed opposite each other.

13. The striker of claim 12 wherein the tab extends outwardly from the third surface.

14. The striker of claim 12 wherein the indentation extends from the first surface toward the second surface and from the third surface toward the fourth surface.

15. The striker of claim 14 wherein the indentation includes a curved surface that extends from the first surface to the tab and has opposing ends that are disposed adjacent to the tab and the third surface.

16. The striker of claim 14 wherein the indentation is spaced apart from the second and fourth surfaces.

17. The striker of claim 12 wherein the tab includes a first tab surface, a second tab surface spaced apart from the first tab surface, and a third tab surface that extends from the first tab surface to the second tab surface, wherein the third tab surface extends from the third surface.

18. The striker of claim 8 wherein the indentation and the tab are disposed substantially in the center of the third portion between the first and second portions.

19. The striker of claim 8 wherein the indentation is spaced apart from the first and second portions.

20. The striker of claim 8 wherein the tab is spaced apart from the first and second portions.
